(19) United States
(12) Patent Application Publication
(10) Pub. No.: US 2012/0101011 A1
(43) Pub. Date: Apr. 26, 2012

(54) Sliding Member Coating Composition

(75) Inventors: Shin Makino, Aichi (JP); Keisuke Miyamoto, Aichi (JP); Shoko Matsuo, Aichi (JP)

(73) Assignee: AKROS CO., LTD., Aichi (JP)

(21) Appl. No.: 13/266,810

(22) PCT Filed: Apr. 27, 2010
(86) PCT No.: PCT/JP2010/057447

§ 371 Date: Nov. 17, 2011

(30) Foreign Application Priority Data
May 1, 2009 (JP) 2009-112342
Sep. 28, 2009 (JP) 2009-222795

(51) Int. Cl. F16C 33/20

(52) U.S. Cl. 508/100

(57) ABSTRACT

There is provided a sliding member coating composition for forming a coating on the surface of a sliding member, which contains a binder resin, abrasion inhibiting members, and a solid lubricant as needed. The shape of the abrasion inhibiting members is a panel shape having an aspect ratio of 5 to 100 expressed by average particle diameter/average particle thickness, and has an average particle diameter of 15.0 μm or smaller and a Moh's hardness of 6 or higher. The content of the solid lubricant can be set to 0 to 15 parts by weight with respect to 100 parts by weight of the binder resin, and the content of the abrasion inhibiting members to 1 to 100 parts by weight with respect to 100 parts by weight of the binder resin. The solid lubricant may not be blended. The abrasion inhibiting members are preferably aluminas. According to the sliding member coating composition in the present invention, even when being exposed to severe frictional conditions for a long time, preferable lubricity can be guaranteed.

### CROSS REFERENCE TO RELATED APPLICATIONS

This application is a 35 U.S.C. §371 national stage application of PCT/JP2010/057447 filed Apr. 27, 2010, which claims the benefit of Japanese Application No. 2009-112342 filed May 1, 2009 and Japanese Application No. 2009-222795 filed Sep. 28, 2009, all of which are incorporated herein by reference in their entireties for all purposes.

### STATEMENT REGARDING FEDERALLY SPONSORED RESEARCH OR DEVELOPMENT

Not applicable.

### BACKGROUND OF THE INVENTION

1. Technical Field

The present invention relates to a sliding member coating composition used for forming a coating of a dry coating lubricant for improving abrasion-resistant properties, anti-burning properties and the like while reducing a coefficient of friction.

2. Background Art

Examples of a sliding member in an automotive vehicle include a bearing for an engine, a piston of an engine, a piston ring, and a swash plate of a swash plate compressor. For example, the piston slides through the intermediary of engine oil, which serves as lubricating oil, between the piston and a combustion chamber of the engine as a counterpart. At this time, lubricity between a piston skirt and a cylinder is important. More specifically, if the lubricity is low between the piston skirt and the cylinder when thermal energy is converted into power in an internal combustion engine, a burning phenomenon may be resulted, and hence the engine comes to a stop. Therefore, application of a coating (coating layer) on a surface (sliding surface) of the piston skirt in contact with the cylinder has been performed in the related art. With the provision of this coat, reduction of a coefficient of friction, improvement of abrasion-resistant properties, improvement of anti-burning properties, and the like on the sliding surface are achieved. Same applies to the sliding surfaces of the various sliding members described above. A sliding member coating composition of this type generally contains a binder resin, a solid lubricant, an inorganic filling material (filler), and other additives as needed. The inorganic filling material has a function as abrasion inhibiting members.

As for the sliding member coating composition of this type, there is JP-A-2006-45463 (Patent Document 1). In this document, plate-shaped abrasion inhibiting members having a predetermined aspect ratio and a grain diameter are blended in a predetermined binder resin. Accordingly, the coefficient of friction can be reduced further than the sliding member coating composition of the related art, and the abrasion-resistant properties and the anti-burning properties are further improved. In Patent Document 1, a combination of the predetermined binder resin and the plate-shaped abrasion inhibiting members are considered to be important. In contrast, the blended amount of composition of the solid lubricant in Patent Document 1 may be on the order of the amount used generally in the related art. More specifically, it is 5 to 250 parts by weight and, more preferably, 10 to 150 parts by weight with respect to 100 parts by weight of a binder resin. In Patent Document 1, in an effect verification test of the sliding member coating composition, a composition containing 20 parts by weight of a solid lubricant with respect to 100 parts by weight of the binder resin is used.

### SUMMARY OF THE INVENTION

### Problems to be Solved by the Invention

In Patent Document 1, by using the plate-shaped abrasion inhibiting members with respect to the predetermined binder resin, more reduction of the coefficient of friction, and more improvement of the abrasion-resistant properties and the anti-burning properties are achieved in comparison with a case where spherical-shaped abrasion inhibiting members are used. However, it was found that a solid lubricant might have an adverse effect on a coating when the plate-shaped abrasion inhibiting members are used. In the related art, the solid lubricant is blended mainly to reduce the coefficient of friction in general. However, it was found that the strength of the coating was lowered if a large amount of solid lubricant was blended when the plate-shaped abrasion inhibiting members were used. Consequently, the coating is susceptible to breakage due to the sliding movement with respect to a counterpart. As a result, defective operation of the sliding member may be resulted.

The present invention is intended to solve the above-described problem. It is an object of the present invention to provide a sliding member coating composition from which a coating having not only a low coefficient of friction, superior abrasion-resistant properties, anti-burning properties, and the like, but also a further desirable coating strength can be formed.

### Means for Solving the Problems

The present invention provides a sliding member coating composition for forming a coating on a surface of a sliding member basically comprising: a binder resin, abrasion inhibiting members, and a solid lubricant. The abrasion inhibiting members have a plate shape having an aspect ratio of 5 to 100 expressed by average particle diameter/average particle thickness, have an average particle diameter of 15.0 μm or smaller and a Moh's hardness of 6 or higher. On that basis, the content of the solid lubricant is characterized by being 0 to 15 parts by weight with respect to 100 parts by weight of the binder resin. The expression “the content of the solid lubricant is 0 parts by weight with respect to 100 parts by weight of a binder resin” means that no solid lubricant is contained. In other words, in the sliding member coating composition according to the present invention, the solid lubricant is not necessarily required, and a case where no solid lubricant is contained is also included. In the present invention, what is essential is that at least the binder resin and the abrasion inhibiting members are contained, and the solid lubricant may be added as needed.

Preferably, the content of the abrasion inhibiting members is 1 to 100 parts by weight with respect to 100 parts by weight of the binder resin. The abrasion inhibiting members are preferably aluminas. Examples of the sliding members include a member configured to slide with respect to a counterpart in the presence of lubricant.

### Advantages of the Invention

According to the present invention, by containing the plate-shaped abrasion inhibiting members, the effects in Patent Document 1 are achieved. The plate-shaped abrasion inhibiting members have a larger surface area per mass than granular particles such as complete sphere or granular particles such as aggregated particles. Therefore, a contact surface area with the binder resin is large. Accordingly, the plate-shaped abrasion inhibiting members are strongly adhered in the binder resin. In addition, the plate-shaped abrasion inhibiting members are aligned in parallel to the contact surface between the coating and a base (sliding member) in the coating after having hardened. Accordingly, in the coating, increase in internal agglutination force in the direction parallel to the contact surface is inhibited. The internal agglutination force in the parallel direction has an adverse effect on adhesiveness of the contact surface. Also, by the alignment of the plate-shaped abrasion inhibiting members in parallel to the contact surface, the coefficient of friction can hardly be increased. The aggression with respect to the counterpart is lowered. In contrast, the internal agglutination force in the vertical direction with respect to the contact surface between the coating and the base is secured. Accordingly, abrasion-resistant properties with respect to friction applied on the sliding surface in the parallel direction are improved in combination with the hardness of the abrasion inhibiting members. In other words, the coefficient of friction can be reduced and the abrasion-resistant properties and the anti-burning properties of the coating are improved depending on the shape and the hardness of the abrasion inhibiting members. With the formation of the coating having such superior properties, reduction of a frictional torque and abrasion of the siding member due to the sliding movement are alleviated.

On that basis, in the present invention, the solid lubricant of an amount suitable for the usage of the plate-shaped abrasion inhibiting members is contained. Accordingly, a desirable coating strength can be also secured while maintaining the above-described superior performances caused by the plate-shaped abrasion inhibiting members. When focusing only on the relationship between the binder resin and the abrasion inhibiting members, the solid lubricant is an impurity. In other words, only an internal agglutination mechanism specific for the coating in which the plate-shaped abrasion inhibiting members are aligned in parallel to the contact surface between the coating and the base the solid lubricant is the impurity. However with the solid lubricant blended within a range which does not impair the internal agglutination mechanism, a desirable coating strength can be secured. Accordingly, the coating is adequately maintained under the severer conditions. Accordingly, damages or defective operations of the sliding member and the counterpart can be avoided.

### BRIEF DESCRIPTION OF THE DRAWINGS

FIG. 1 is a schematic drawing of a thrust tester.

FIG. 2 is a schematic drawing of a block-on-ring tester.

### BEST MODES FOR CARRYING OUT THE INVENTION

Detailed description about a sliding member coating composition according to the present invention will be given below. The sliding member coating composition according to the present invention is a sliding member coating composition used for forming a coating (coating layer) of a dry coating lubricant for improving abrasion resistant properties, anti-burning properties, and the like while reducing a coefficient of friction. As a basic composition of the sliding member coating composition, a binder resin, an inorganic filling material as the abrasion inhibiting members, and a solid lubricant as needed are contained. In the following description, the sliding member coating composition may be referred to simply as a composition for the sake of convenience.

[Binder Resin] The type of the binder resin is not specifically limited. A known resin used as the binder resin for the sliding member coating composition of the related art may be used. As described later, it is because the strength of the coating does not necessarily have to be guaranteed by a specific binder resin since the blended amount of the solid lubricant is reduced. For example, thermoplastic resins such as polyamide imide resin, polyvinyl butyral, chlorinated polyolefin rein, nylon, polyether imide, polyether sulfone, thermoplastic polyimide may be used. Also, thermosetting resins such as alkyd resin, epoxy resin, amino resin, acryl resin, polyamino amide resin, polyurethane resin, unsaturated polyester resin, phenol resin, xylene resin, vinyl ester resin, furan resin, silicone resin, polyimide, wholly aromatic polyester may be used. Among the thermoplastic resins, polyamide imide resin, polyvinyl butyral, polyether sulfone, and thermoplastic polyimide are preferable. Among the thermosetting resins, epoxy resin, amino resin, acryl resin, polyamino amide resin, polyurethane resin, unsaturated polyester resin, phenol resin, xylene resin, silicone resin, and polyimide are preferable. These resins are easy to handle, and may be used to form a coating in a state of paint while containing the plate-shaped abrasion inhibiting members satisfactorily dispersed therein. In addition, in view of adhesiveness, chemical resistant properties, and strength, polyamide imide resin, polyether sulfone, and thermoplastic polyimide, epoxy resin, or polyimide resin are more preferable. In view of necessities of coating workability when the coating is formed and heat-resistant property with respect to heat generation caused by friction, polyamide imide resin is most preferably followed by polyether sulfone and thermoplastic polyimide.

The binder resins as described above may be used singularly or two or more types of resin mixed together. When using the thermosetting resin, a curing agent is added as needed. For example, when epoxy resin is used, polyamino amide resin, amino resin, or phenol resin is mixed as the curing agent. In particular, when the sliding member is made of plastic, it is preferable to mix epoxy resin and polyamino amide resin for use. In contrast, polyether sulfone or polyimide (including thermoplastic polyimide) may be used singularly.

When the polyamide imide resin is used, epoxy resin may be mixed for use in order to improve adhesiveness or low-temperature curing properties. In this case, the blended amount of epoxy resin is preferably on the order of 1 to 50 parts by weight and, more preferably, on the order of 5 to 30 parts by weight with respect to 100 parts by weight of polyamide imide resin. Also, in order to improve the adhesiveness or toughness, polyvinyl butyral may be mixed for use. In this case, the blended amount of polyvinyl butyral is preferably on the order of 1 to 30 parts by weight and, more preferably, on the order of 5 to 20 parts by weight with respect to 100 parts by weight of polyamide imide resin.

In the preset invention, since the blended amount of the solid lubricant falls within a range which does not impair the adhesiveness between the binder resin and the plate-shaped abrasion inhibiting members, the breaking strength or the breaking elongation of the binder resin may be relatively smaller than those in Patent Document 1 described above. More specifically, the mechanical strength of the binder resin is preferably 80 to 150 MPa in breaking strength and 10 to 40% in breaking elongation. If the breaking strength of the binder resin is lower than 80 MPa, the formed coating may be ruptured by the sliding movement with respect to the counterpart due to the insufficient strength. Therefore, the abrasion-resistant of the coating can hardly be secured. In contrast, when the breaking strength of the binder resin exceeds 150 MPa, the molecular weight of the binder resin is high and hence the viscosity is increased, so that the number of steps or the cost may be increased. Also, when the breaking elongation of the binder resin is lower than 10%, an effect of reducing the coefficient of friction by dispersing the contact stress becomes insufficient. In contrast, when the breaking elongation of the binder resin exceeds 40%, the amount of deformation of the coating is increased, so that the adhesiveness with respect to a base is degraded. More preferably, the breaking strength of the binder resin is 85 to 110 MPa.

[Abrasion Inhibiting Members] As the abrasion inhibiting members, various types of plate-shaped inorganic fine particles having a Moh's hardness of 6 or higher may be used. For example, aluminas such as aluminum oxide, aluminum hydroxide, alumina white, and silica alumina may be used. In addition to aluminas, zirconia, tungsten carbide, titanium carbide, silicon carbide, titanium dioxide, iron oxide, feldspar, pumice stone, common feldspar, iridium, quartz, silica, beryllium oxide, zirconium oxide, chrome, boron carbide, tungsten carbide, silicone carbide, diamond, and so on may be used. These abrasion inhibiting members may be used singularly or two or more types of materials mixed together. Also, composite material including two or more types of materials, or those applied with some surface treatment or surface modification is also applicable. If the Moh's hardness is 6 or higher, a desirable hardness is applied to the coat, and the abrasion-resistant properties or the anti-burning properties are improved. Among them, aluminas having a Moh's hardness on the order of 9 is preferable. The aluminas are specifically suitable in a case where the coating is formed on a surface which slides with respect to a metal surface of the counterpart in the presence of lubricant such as a sliding surface of a piston skirt of an engine, for example.

The shape of the abrasion inhibiting members is a flat panel shape having an aspect ratio of 5 to 100 expressed by average particle diameter/average particle thickness. With the abrasion inhibiting members having an aspect ratio lower than 5, the shape becomes close to a spherical shape, which loses a specific effect of the plate-shaped abrasion inhibiting members. With the abrasion inhibiting members having an aspect ratio higher than 100, the average particle thickness is too small with respect to the average particle diameter, so that the abrasion inhibiting members may suffer from a deficit in a paint dispersing process or the like. Preferably, the abrasion inhibiting members have an aspect ratio from 5 to 80 and, more preferably, an aspect ratio from 10 to 70. As long as the plate-shaped abrasion inhibiting members have an aspect ratio within this range, there are less pointed surfaces, and hence the hardness is desirably maintained and aggression to the counterpart is reduced. Therefore, the coating is reinforced due to the hardness of the abrasion inhibiting members and, on the other hand, increase in coefficient of friction due to the presence thereof is effectively inhibited.

The plate-shaped abrasion inhibiting members having the aspect ratios as described above are aligned in parallel with the surface of the base in the coating (parallel to the direction of surface of the coat). Accordingly, pointed contact between the coating and the counterpart is avoided. Consequently, increase in coefficient of friction is effectively inhibited. Also, expansion and contraction of the coating in the surface direction is constrained. Therefore, an internal stress of the coating is hardly increased, so that the adhesiveness between the coating and the base is improved. In addition, since the plate-shaped abrasion inhibiting members are aligned in parallel with the direction of the surface of the coat, even when the plate-shaped abrasion inhibiting members are exposed from the surface due to abrasion of the coat, increase in coefficient of friction is inhibited in comparison with the spherical-shaped abrasion inhibiting members.

The average particle diameter and the average particle thickness are obtained as follows. The average particle thickness is obtained by selecting ten arbitrary particles by observing the abrasion inhibiting members using a scanning type electronic microscope, measuring the thicknesses of the respective members, and calculating an average. The average particle diameter is obtained by selecting ten arbitrary particles by observing the abrasion inhibiting members using the scanning type electronic microscope, measuring the long diameter and the short diameter of the respective members, and calculating an average from (long diameter+short diameter)/2.

The average particle diameter of the abrasion inhibiting members is 15.0 μm or smaller. When the average particle diameter of the abrasion inhibiting members exceeds 15.0 μm, probability of projection of the abrasion inhibiting members from the surface of the coating is increased. In this case, increase in coefficient of friction or increase in aggression to the counterpart may be caused. The average particle diameter of the abrasion inhibiting members is preferably on the order of 0.5 to 10.0 μm. Within this range, assuming that the coating having a thickness on the order of 10 to 15 μm is formed, the average particle diameter of the abrasion inhibiting members falls within a range of about 3 to 100% with respect to the thickness of the coat. Therefore, parallel alignment of the abrasion inhibiting members with respect to a contact surface between the coating and the base is easily achieved. Accordingly, specific effects of having a plate-shape can be brought out in an appropriate manner. Furthermore, the aggression with respect to the counterpart is low, and hence the effect of reducing the coefficient of friction is desirably brought out.

A range of 1 to 100 parts by weight of the abrasion inhibiting members is contained in 100 parts by weight of the binder resin. Within this range, effects of reduction of the coefficient of friction and improvement of the abrasion-resistant properties and the anti-burning properties with the presence of the abrasion inhibiting members can be desirably brought out. In particular, the above-described effects can be brought out even with 1 parts by weight with respect to 100 parts by weight of the binder resin. If the abrasion inhibiting members are less than 1 parts by weight with respect to 100 parts by weight of the binder resin, significant effect of adding the abrasion inhibiting members can hardly be obtained. In contrast, if 100 parts by weight is exceeded, the content of the binder resin is relatively lowered. Therefore, the adhesiveness with respect to the base is lowered and hence the coating is susceptible to separation. The content of the abrasion inhibiting members is preferably on the order of a range from 1 to 80 parts by weight with respect to 100 parts by weight of the binder resin, and more preferably on the order of a range from 3 to 40 parts by weight with respect to 100 parts by weight of the binder resin and, more preferably, on the order of a range from 3 to 15 parts by weight with respect to the 100 parts by weight of the binder resin. Even with the small amount of the plate-shaped abrasion inhibiting members, sufficient lubricating properties are brought out, so that the cost reduction is achieved by reducing the content. The reason why the upper limit of the content of the abrasion inhibiting members may be higher than that in Patent Documents 1 described above is because the blended amount of the solid lubricant is small as described later.

[Solid Lubricant] The type of the solid lubricant is not specifically limited. A known solid lubricant used in the sliding member coating composition of the related art may be used. For example, in addition to fluorine compounds such as polytetrafluoroethylene (PTFE), tetrafluoroethylene-perfluoroalkyl vinyl ether copolymer, tetrafluoroethylene-hexafluoropropylene copolymer, tetrafluoroethylene-ethylene copolymer, and polyvinylidene fluoride and polychrolotrifluoroethylene, sulfides such as molybdenum disulfide (MoS₂) and tungsten disulfide (WS₂), laminar flake substances such as black lead (graphite), graphite fluoride, boron nitride, and mica, soft metals such as lead, zinc, and copper, and melamine cyanurate, and so on may be exemplified. Among them, polytetrafluoroethylene, molybdenum disulfide, tungsten disulfide, and black lead are specifically desirable. These substances may be used singularly or two or more types of resins mixed together.

The solid lubricant has an effect of reducing the coefficient of friction. However, it is important that the content of the solid lubricant is 0 to 15 parts by weight with respect to 100 parts by weight of the binder resin. In the present invention, the solid lubricant may not be blended. If the amount of the solid lubricant is larger than 15 parts by weight, the effect of having blended the plate-shaped abrasion inhibiting members tends to be impaired, so that the coating strength is lowered. Consequently, separation of the coating from the surface of the base may be resulted due to the sliding friction with the counterpart. The content of the solid lubricant is preferable 0.1 to 12 parts by weight with respect to the 100 parts by weight of the binder resin. By blending the solid lubricant, a synergetic effect is obtained, and the lesser the blended amount of the solid lubricant, the more the adverse effect on the plate-shaped abrasion inhibiting members is reduced.

The average particle diameter of the solid lubricant is preferably 15.0 μm or smaller. If the average particle diameter of the solid lubricant exceeds the 15.0 μm, the particle diameter is too large with respect to the thickness of the coat, so that the solid lubricant is susceptible to dropping from the coat.

[Other Additives] The composition of the present invention may be blended with other general additives without impairing the effects of the binder resin, the plate-shaped abrasion inhibiting members, and the solid lubricant. Examples of the additives include a dispersing agent, a silane coupling agent, a leveling agent, a surface active agent, a viscosity bodying agent, and a pigment. The dispersing agent aids dispersion of the abrasion inhibiting members and the solid lubricant. The silane coupling agent aids improvement of affinity of the abrasion inhibiting members or improvement of adhesiveness. The leveling agent and the surface active agent control a surface tension. The viscosity bodying agent controls the thixotropic characteristics. Examples of the pigment include coloring pigments represented by carbon black, titanium oxide, and iron oxide, a corrosion inhibiting pigment which inhibits occurrence of corrosion, and an extender pigment which controls the properties of the paint or the coat.

[Method of Painting] The composition according to the present invention may be applied according to a known general painting method after the binder resin is dissolved using a solvent to lower its viscosity. More specifically, first of all, the binder resin is dissolved in an organic solvent. The organic solvent is not specifically limited as long as it is an organic solvent which is capable of dissolve the binder resin. Solvents with respect to representative resins which may be used include ketones such as methyl ethyl ketone, esters such as ethyl acetate, aromatic series solvent such as xylene and toluene in the case of epoxy resin. In the case of polyimide imide resin, NMP (N-methyle-2-pyrolidone) may be used. Also, mixed solvent prepared by adding aromatic series solvent such as xylene, ketones such as methyl ethyl ketone, esters such as ethyl acetate to NMP may be used. The plate-shaped abrasion inhibiting members, the solid lubricant, and other additives as needed are added to a solvent having the binder resin dissolved therein, and dispersed using a dispersing machine such as a ball mill. In this manner, the sliding member coating composition may be conditioned.

The sliding member coating composition conditioned in this manner is applied to the surface of the sliding member to form the coat. The sliding member is a member to be applied with the coating of the known sliding member coating composition such as sliding members for automotive vehicles, sliding members for Office Automation equipment, sliding members for light electrical appliances. In particular, it is suitable for members which slide in the presence of lubricant. The material of the sliding members or the sliding surfaces on which the sliding member coating composition can be applied is not specifically limited. Examples of the material of the sliding member or the sliding surface include, for example, metal such as aluminum or iron, alloy, rubber, plastic, and elastomer. Various application equipment may be used for applying the sliding member coating composition. Examples of the application equipment include a brush, a roller, a roll coater, an air spray, an airless spray, an electrostatic applicator, an immersion application, an electrodeposition applicator, a screen printer, a pat printer, a gravure coater. The sliding member coating composition is applied, and then is baked under hardening conditions which cause the binder resin to be dried and hardened to form a coat. Baking conditions are not specifically limited. In general, baking is continued for 5 to 180 minutes at a baking temperature within a range from the room temperature (23° C.) to 350° C. The thickness of the coating after the baking is not specifically limited as well. In general, the thickness is from 1 to 50 μm and preferably from 5 to 30

The sliding surface of the sliding member may be applied with preparatory process such as alkali degreasing and solvent degreasing, shotblasting, etching, and chemical conversion treatment as needed. Also, the sliding surface of the sliding member applied with an undercoat and a pre-coat may be applied with the sliding member coating composition according to the present invention.

(Evaluation Test 1)

Polyamide imide resin as a binder resin, plate-shaped alumina having an average particle diameter of 5 μm and an aspect ratio of 20 to 30 as abrasion inhibiting members, and PTFE as a solid lubricant were used to prepare compositions 1 to 30 having blends shown in Table 1, and the abrasion-resistant properties, the anti-burning properties, and the coating strength of the compositions 1 to 30 under testing conditions severer than those in Patent Document 1 were evaluated. The results are also shown in Table 1. The numerical values indicating the content in Table 1 are parts by weight.

(Method of Measuring Burning Load and Coating Surface Observation)

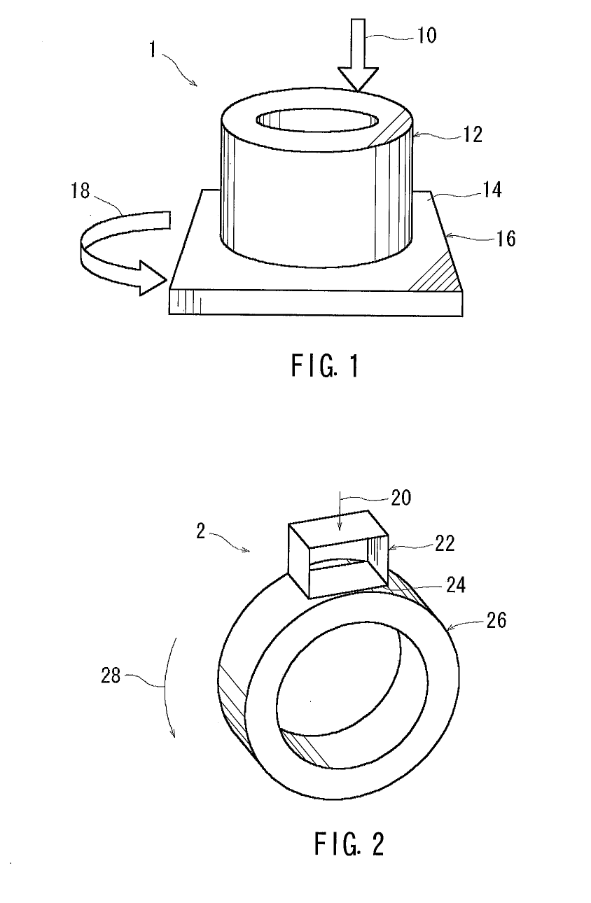

The thrust tester 1 (A & D Company, Limited) shown in FIG. 1 was used to measure the burning load. A plate-shaped test panel 16 (3×30×30 mm, Material AC8A, roughness Rz=0.5 μm) was used as the sliding member to be formed with a coat. In FIG. 1, an upper surface (first sliding surface 14) of the test panel 16 is applied with solvent degreasing as a preprocess. The respective compositions was sprayed on the first sliding surface 14, and was dried (180° C., 90 min) to form a coat. The thickness of the coating was 10 μm. In this test, since the surface roughness of the test panel 16 was Rz=0.5 μm, it is understood that the conditions are hard because the adhesiveness could hardly be secured and separation of the coating was susceptible to occur in comparison with Rz=1.0 μm in Patent Document 1.

As a first counterpart 12, a member having a hollow cylindrical shape (φ25.6 mm in outer diameter, φ20 mm in inner diameter, FC250 in quality of material, and roughness Rz=1 μm) was used. The first counterpart 12 was arranged on the first sliding surface 14 applied with the coat. In this state, the test panel 16 was rotated (number of revolution 1000 rpm) in the direction indicated by an arrow 18 in FIG. 1. Then, after the burn-in rotation (a pressing load of 245 N was applied for 10 minutes), the pressing load was applied on the first counterpart 12 from the direction indicated by an arrow 10 in FIG. 1, and the pressing load was increased to 4900N at regular cycles (245N/2 min). This test was conducted while being lubricated by lubricant (mineral oil: 5W-30), and the oil temperature of the lubricant was started from the room temperature and then was left on a go-it-alone basis. At a timing when the coefficient of friction with respect to the first counterpart 12 of the first sliding surface 14 exceeded 0.10 was defined as “the timing when burning occurred”, the load at that timing was measured as the burning load. The limit of the burning load which could be measured by this tester was 4900N. Therefore, the expression “>4900” in Table 1 means that the burning load exceeded 4900N, and the burning was not occurred in this test. After the test has finished, the surface observation on the tested surface was performed through visual observation, and the state of the coating was evaluated by the following standards.

double circles: coating remained and no part of base was exposed
circles: most parts of coating remained and base was little exposed
triangles: coating was partly separated
crosses: burned and no coating remained

### Method of Abrasion-Resistant Properties

A block-on-ring tester 2 (FALEX LFW-1, FALEX CORPORATION) shown in FIG. 2 was used to evaluate the abrasion-resistant of the coat. A block-shaped test material 22 (6×16×10 mm, AC8A in quality of material, surface roughness Rz=1 μm) was used as the sliding member to be formed with a coat. In FIG. 2, a lower surface (second sliding surface 24) of the test material 22 is applied with the solvent degreasing as a preprocess. The respective test compositions were sprayed on the second sliding surface 24 and were dried (180° C., 90 min.) to form a coat. The thickness of the coating was 10 μm.

Also, as a second counterpart 26, a ring-shaped member (φ35 mm in outer diameter, 8 mm in thickness, FC250 (gray cast iron) in quality of material, and surface roughness Rz=1 μm) was used. The second counterpart 26 was brought into abutment with the second sliding surface 24. In this state, the second counterpart 26 was rotated (at a revolution speed of 500 rpm) in the direction indicated by an arrow 28 in FIG. 2, the pushing load (245N) was applied on the test material 22 from the direction indicated by an arrow 20 in FIG. 20, and the amount of abrasion (μm) of the coating when 4 hours has elapsed from the start of the test was measured. This test was conducted while being lubricated by lubricant (mineral oil: 5W-30). The oil temperature of the lubricant was 80° C. The standards of evaluation in Table 1 are as follows.

double circles: amount of abrasion of coating was less than 5 μm
circles: coating remained
crosses: no remaining coating was shown

In this test, the pressing load was 245N, and the test duration was 4 hours. In Patent Document 1, the pressing load was 55 N, and the time duration was five minutes, and hence it was understood that the conditions in this test were severer in terms of both the load and the sliding time.

TABLE 1

| | | PLATE-SHAPED | | | | | |
|---|---|---|---|---|---|---|---|
| | | ABRASION | SOLID LUBRICANT | | ABRASION- | | |
| | BINDER | INHIBITING | | ADDED | RESISTANT | BURNING | SURFACE |
| COMPOSITION | RESIN | MEMBER | TYPE | AMOUNT | PROPERTY | LOAD (N) | OBSERVATION |
| 1 | 100 | 1 | | 0 | ∘ | >4900 | ∘ |
| 2 | 100 | 1 | PTFE | 0.3 | ∘ | >4900 | □ |
| 3 | 100 | 1 | PTFE | 1 | ∘ | >4900 | □ |
| 4 | 100 | 1 | PTFE | 5 | ∘ | >4900 | □ |
| 5 | 100 | 1 | PTFE | 10 | ∘ | >4900 | □ |
| 6 | 100 | 1 | PTFE | 15 | ∘ | >4900 | ∘ |
| 7 | 100 | 1 | PTFE | 20 | ∘ | 2695 | x |
| 8 | 100 | 5 | | 0 | □ | >4900 | □ |
| 9 | 100 | 5 | PTFE | 0.3 | □ | >4900 | □ |
| 10 | 100 | 5 | PTFE | 1 | □ | >4900 | □ |
| 11 | 100 | 5 | PTFE | 5 | □ | >4900 | □ |
| 12 | 100 | 5 | PTFE | 10 | □ | >4900 | □ |
| 13 | 100 | 5 | PTFE | 15 | ∘ | >4900 | ∘ |
| 14 | 100 | 5 | PTFE | 20 | ∘ | >4900 | □ |
| 15 | 100 | 30 | | 0 | □ | >4900 | □ |
| 16 | 100 | 30 | PTFE | 0.3 | □ | >4900 | □ |
| 17 | 100 | 30 | PTFE | 1 | □ | >4900 | □ |
| 18 | 100 | 30 | PTFE | 5 | □ | >4900 | □ |
| 19 | 100 | 30 | PTFE | 10 | □ | >4900 | □ |
| 20 | 100 | 30 | PTFE | 15 | ∘ | >4900 | ∘ |
| 21 | 100 | 30 | PTFE | 20 | ∘ | 3675 | x |
| 22 | 100 | 100 | | 0 | □ | >4900 | ∘ |
| 23 | 100 | 100 | PTFE | 0.3 | □ | >4900 | ∘ |
| 24 | 100 | 100 | PTFE | 1 | □ | >4900 | ∘ |
| 25 | 100 | 100 | PTFE | 5 | □ | >4900 | ∘ |
| 26 | 100 | 100 | PTFE | 10 | □ | >4900 | ∘ |
| 27 | 100 | 100 | PTFE | 15 | ∘ | >4900 | ∘ |
| 28 | 100 | 100 | PTFE | 20 | ∘ | 3185 | x |
| 29 | 100 | 0 | PTFE | 0.3 | x | 2205 | x |
| 30 | 100 | 150 | PTFE | 0.3 | x | 1470 | x |

From the results on compositions 1, 8, 15, 22, it was found that if the plate-shaped abrasion inhibiting members were used, these compositions were capable of resisting severer frictional conditions even though the solid lubricant was not blended, and desirable lubricity was expressed. In particular, even though the content of the plate-shaped abrasion inhibiting members was 1 parts by weight with respect to 100 parts by weight of the binder resin as the composition 1, it was found that the composition was capable of resisting the severer frictional conditions, and desirable lubricity was expressed. Also, if the content of the solid lubricant was 15 parts by weight with respect to 100 parts by weight of the binder resin, from the result on a composition 27, it was found that even though the content of the plate-shaped abrasion inhibiting members with respect to 100 parts by weight of the binder resin was 100 parts by weight, the composition 27 was capable of resisting the severer conditions, and desirable lubricity was expressed. In contrast, with a composition 21 which has the same composition as that in an embodiment of the Patent Document 1 described above, it was found that part of the coating was separated under the severer frictional conditions.

Since the result on a composition 2 was better than the composition 1, it was found that blending the solid lubricant even a little amount was preferable in comparison with the composition not blended with the solid lubricant. From the results on compositions 7, 14, 21, and 28, it was found that if the blended amount of the solid lubricant was large (20 parts by weight with respect to 100 parts by weight of the binder resin), the coating strength was lowered, and could not resist the severer frictional conditions. However, in the case of the composition 14 whose content of the plate-shaped abrasion inhibiting members was 5 parts by weight with respect to 100 parts by weight of the binder resin, the extent of coating separation was insignificant. In contrast, if the content of the solid lubricant was on the order of 15 parts by weight with respect to 100 parts by weight of the binder resin like compositions 6, 13, 20, and 27, it was found that the adverse effect on the coating strength or the lubricating properties was insignificant. Also, since the results of the test on compositions 5, 12, 19, and 26 are better than those of the compositions 6, 13, 20, and 27, it was found that the smaller content of the solid lubricant (not more than 10 parts by weight with respect to 100 parts by weight of the binder resin, for example) was more preferable. The results were totally preferable on compositions 8 to 14 whose content of the abrasion inhibiting members was 5 parts by weight and compositions 15 to 21 whose content of the abrasion inhibiting members was 30 parts by weight than composition 1 to 7 whose content of the abrasion inhibiting members was 1 parts by weight and compositions 22 to 28 whose content of the abrasion inhibiting members was 100 parts by weight. In particular, from the result on the composition 14, it was confirmed that the composition whose content of the abrasion inhibiting members was 5 parts by weight reflects the best trend.

From the result on the composition 30, it was found that even though the content of the solid lubricant was small, if 150 parts by weight of the plate-shaped abrasion inhibiting members were blended with respect to 100 parts by weight of the binder resin, both of the frictional properties and the coating strength were lowered. From the result on the composition 29, it was found that if the solid lubricant was blended but the abrasion inhibiting members were not blended, the desirable frictional properties and the coating strength could not be obtained.

Evaluation Test 2

Subsequent to Evaluation Test 1 using PTFE as the solid lubricant, compositions 31 to 55 were prepared using molybdenum disulfide (MoS₂) as the solid lubricant and Evaluation Test 2 was performed under the same conditions on the same evaluation items as Evaluation Test 1. The compositions of the compositions 31 to 55 used in Evaluation Test 2 and the test results are shown in

TABLE 2
The numerical values indicating the content in Table 2 are parts by weight.

| | | PLATE-SHAPED | SOLID | | | | |
|---|---|---|---|---|---|---|---|
| | | ABRASION | LUBRICANT | | ABRASION- | | |
| | BINDER | INHIBITING | | ADDED | RESISTANT | BURNING | SURFACE |
| COMPOSITION | RESIN | MEMBER | TYPE | AMOUNT | PROPERTY | LOAD (N) | OBSERVATION |
| 31 | 100 | 1 | MoS₂ | 0.3 | ∘ | >4900 | □ |
| 32 | 100 | 1 | MoS₂ | 1 | ∘ | >4900 | □ |
| 33 | 100 | 1 | MoS₂ | 5 | ∘ | >4900 | □ |
| 34 | 100 | 1 | MoS₂ | 10 | ∘ | >4900 | □ |
| 35 | 100 | 1 | MoS₂ | 15 | ∘ | >4900 | ∘ |
| 36 | 100 | 1 | MoS₂ | 20 | ∘ | 3920 | x |
| 37 | 100 | 5 | MoS₂ | 0.3 | □ | >4900 | □ |
| 38 | 100 | 5 | MoS₂ | 1 | □ | >4900 | □ |
| 39 | 100 | 5 | MoS₂ | 5 | □ | >4900 | □ |
| 40 | 100 | 5 | MoS₂ | 10 | □ | >4900 | □ |
| 41 | 100 | 5 | MoS₂ | 15 | ∘ | >4900 | ∘ |
| 42 | 100 | 5 | MoS₂ | 20 | ∘ | >4900 | □ |
| 43 | 100 | 30 | MoS₂ | 0.3 | □ | >4900 | □ |
| 44 | 100 | 30 | MoS₂ | 1 | □ | >4900 | □ |
| 45 | 100 | 30 | MoS₂ | 5 | □ | >4900 | □ |
| 46 | 100 | 30 | MoS₂ | 10 | □ | >4900 | □ |
| 47 | 100 | 30 | MoS₂ | 15 | ∘ | >4900 | ∘ |
| 48 | 100 | 30 | MoS₂ | 20 | ∘ | >4900 | □ |
| 49 | 100 | 100 | MoS₂ | 0.3 | □ | >4900 | ∘ |
| 50 | 100 | 100 | MoS₂ | 1 | □ | >4900 | ∘ |
| 51 | 100 | 100 | MoS₂ | 5 | □ | >4900 | ∘ |
| 52 | 100 | 100 | MoS₂ | 10 | □ | >4900 | ∘ |
| 53 | 100 | 100 | MoS₂ | 15 | ∘ | >4900 | ∘ |
| 54 | 100 | 100 | MoS₂ | 20 | ∘ | 4410 | x |
| 55 | 100 | 150 | MoS₂ | 0.3 | x | 2205 | x |

From the results in Table 2, it was confirmed that even when the molybdenum disulfide was used as the solid lubricant, substantially the same results (tendencies) as the case where PTFE was used were obtained. Therefore, it was confirmed that there was no significant difference depending on the types of the solid lubricants and a wide range of general solid lubricants might be used. However, precisely speaking, since the results on compositions 36, 48, and 54 were somewhat better than the results on the compositions 7, 21, and 28 having the same compositions using PTFE, a tendency such that the range (especially the upper limit) of the allowable blended amount was larger with molybdenum disulfide than with PTFE.

To totally wrap up the results described above, we could draw the fact that in a case where the plate-shaped abrasion inhibiting members were used for the coating for the sliding member which slides with respect to the counterpart in the presence of the lubricant, the content of the abrasion inhibiting members was at least 1 to 100 parts by weight with respect to 100 parts by weight of the binder resin, preferably on the order of a range from 1 to 80 parts by weight with respect to 100 parts by weight of the binder resin, and more preferably on the order of a range from 3 to 40 parts by weight with respect to 100 parts by weight of the binder resin, and, more preferably, on the order of a range from 3 to 15 parts by weight with respect to the 100 parts by weight of the binder resin. Also, we could draw the fact that the solid lubricant does not necessarily have to be added and, if the solid lubricant was added, the upper limit was 15 parts by weight with respect to 100 parts by weight of the binder resin and, preferably, on the order of 0.1 to 12 parts by weight with respect to 100 parts by weight of the binder resin.

1. A sliding member coating composition for forming a coating on a surface of a sliding member comprising:
a binder resin, abrasion inhibiting members, and a solid lubricant as needed;
the abrasion inhibiting members comprising a panel shape having an aspect ratio of 5 to 100 expressed by average particle diameter/average particle thickness, an average particle diameter of 15.0 μm or smaller, and a Moh's hardness of 6 or higher; and
the contents of the solid lubricant is 0 to 15 parts by weight of with respect to 100 parts by weight of the binder resin.

2. The sliding member coating composition according to claim 1, wherein the content of the abrasion inhibiting members is 1 to 100 parts by weight with respect to 100 parts by weight of the binder resin.

3. The sliding member coating composition according to claim 1, comprising one or more type of solid lubricant selected from a group consisting of polytetrafluoroethylene, molybdenum disulfide, tungsten disulfide, and black lead.

4. The sliding member coating composition according to claim 1, wherein the abrasion inhibiting members are aluminas.

5. The sliding member coating composition according to claim 1, comprising one or more binder resin selected from a group consisting of polyamide imide resin, polyethersulfone, thermoplastic polyimide, epoxy resin, and polyimide resin.

6. The sliding member coating composition according to claim 1, wherein the mechanical strength of the binder resin is 80 to 150 MPa in breaking strength and 10 to 40% in breaking elongation.

7. The sliding member coating composition according to claim 1, wherein the abrasion inhibiting members are aligned in parallel with respect to a contact surface with respect to the sliding member in a coating after having hardened.

8. The sliding member coating composition according to claim 1, wherein the sliding member is a sliding member configured to slide with respect to a counterpart in the presence of lubricant.
